(19) United States
(12) Patent Application Publication
(10) Pub. No.: US 2007/0262247 A1
(43) Pub. Date: Nov. 15, 2007

(54) SENSORY FEEDBACK BED

(76) Inventors: Carlos Becerra, Atlanta, GA (US); William K. Chandler, Lawrenceville, GA (US); Scott Powers, Dallas, GA (US); Abebaw Zeleke, Marietta, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 11/463,636

(22) Filed: Aug. 10, 2006

Related U.S. Application Data
(60) Provisional application No. 60/747,065, filed on May 11, 2006.

(51) Int. Cl. G01J 5/08; G02B 6/00

(52) U.S. Cl. 250/227.14; 385/12

(57) ABSTRACT

A mechanism for mapping an anatomical characteristic of a patient includes a treatment bed having a top surface. A fiber Bragg grating channel is disposed along at least a portion of the treatment bed near the top surface and includes a fiber optic waveguide defining a plurality of spaced-apart Bragg-type gratings. A multi-wavelength light source generates a beam that is in optical communication with the fiber Bragg grating channel. A detector, in optical communication with the fiber Bragg grating channel, detects reflections of light from at least one of the Bragg-type gratings. A computer is programmed to calculate at least one anatomical characteristic based on a characteristic of at least one of the reflection of light.

### CROSS REFERENCE TO PROVISIONAL PATENT APPLICATION

This application claims priority on U.S. Provisional Patent Application Ser. No. 60/747,065, filed on May 11, 2006, the entirety of which is incorporated herein by reference.

### BACKGROUND OF THE INVENTION

1. Field of the Invention

The present invention relates to medical treatment devices and, more specifically, to a non-invasive device for measuring properties of a patient.

2. Description of the Prior Art

A treatment bed is a bed upon which a patient lies during examination or treatment. It typically includes a platform and a mattress disposed thereon.

Treatment beds are used in a variety of applications. In one example, a treatment bed may be employed with a spinal treatment system. Such a system may employ a distraction mechanism that applies force in a predetermined direction to a selected portion of the patient's spine. The patient lies on the treatment bed while the distraction mechanism applies the force for a therapeutically effective period of time. Selection of the location and amount of force applied to the patient's spine is a difficult process that depends on several factors, such as the patient's weight, the patient's girth and the depth of the contours of the patient's spine. Currently, this information must be acquired through manual measurement by the clinician and then the set points of the distraction mechanism are manually calculated based on the measured information.

Fiber Bragg gratings have recently been used in measuring strain and other mechanical properties of various structures. A fiber Bragg grating is an optical fiber that includes spaced-apart Bragg-type reflective portions in which each successive reflective portion reflects a different wavelength of light. Each grating can reflect a selected wavelength of light, while transmitting all other wavelengths of the light. U.S. Pat. No. 5,061,032, entitled “Optical waveguide embedded light redirecting and focusing Bragg grating arrangement” and issued to Meltz et al., which is incorporated herein by reference, describes one type of fiber Bragg grating. Currently, no treatment bed employs a fiber Bragg grating to measure physical properties of a patient.

In some treatment scenarios, information about various patient parameters could be useful. For example, the local temperature of a portion of a patient's body can be useful in certain diagnostic and treatment systems.

Therefore, there is a need for a mechanism that senses contour and other parameters relative to a patient and that provides information to a computer about such parameters.

### SUMMARY OF THE INVENTION

The disadvantages of the prior art are overcome by the present invention which, in one aspect, is a mechanism for mapping an anatomical characteristic of a patient that includes a treatment bed having a top surface. A fiber Bragg grating channel is disposed along at least a portion of the treatment bed near the top surface. The fiber Bragg grating channel includes a fiber optic waveguide defining a plurality of spaced-apart Bragg-type gratings. A multi-wavelength light source generates a beam that is in optical communication with the fiber Bragg grating channel. A detector, in optical communication with the fiber Bragg grating channel, detects reflections of light from at least one of the Bragg-type gratings. A computer is programmed to calculate at least one anatomical characteristic based on a characteristic of at least one of the reflection of light.

In another aspect, the invention is a method of measuring an anatomical characteristic of a patient, in which a fiber Bragg grating channel, including a fiber optic waveguide defining a plurality of spaced-apart Bragg-type gratings, is placed in a position so as to have at least one optical characteristic of the fiber Bragg grating channel changed in correspondence with the anatomical characteristic. A light beam from a multi-wavelength light source is injected into the fiber Bragg grating channel. A value of at least one parameter of a beam reflected out of the fiber Bragg grating channel is measured with a detector. The anatomical characteristic is calculated based on the value.

In yet another aspect, the invention is a treatment bed for a patient that includes a platform capable of supporting the patient and a mattress, having a top surface, disposed on the platform. A fiber Bragg grating channel is disposed along at least a portion of the mattress near the top surface. The fiber Bragg grating channel includes a fiber optic waveguide defining a plurality of spaced-apart Bragg-type gratings.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic view of an illustrative embodiment of the invention.

FIG. 1B is a cross-sectional view of the treatment bed shown in FIG. 2A with a person lying thereon.

FIG. 2A is a cross-sectional view of a second illustrative embodiment of the invention.

FIG. 2B is a perspective view of a track mountable fiber Bragg grating channel that may be employed in the embodiment shown in FIG. 3A.

FIG. 3A is a front view of a fiber Bragg grating channel applied to a patient.

FIG. 3B is a front view of a fiber Bragg grating channel array applied to a patient.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

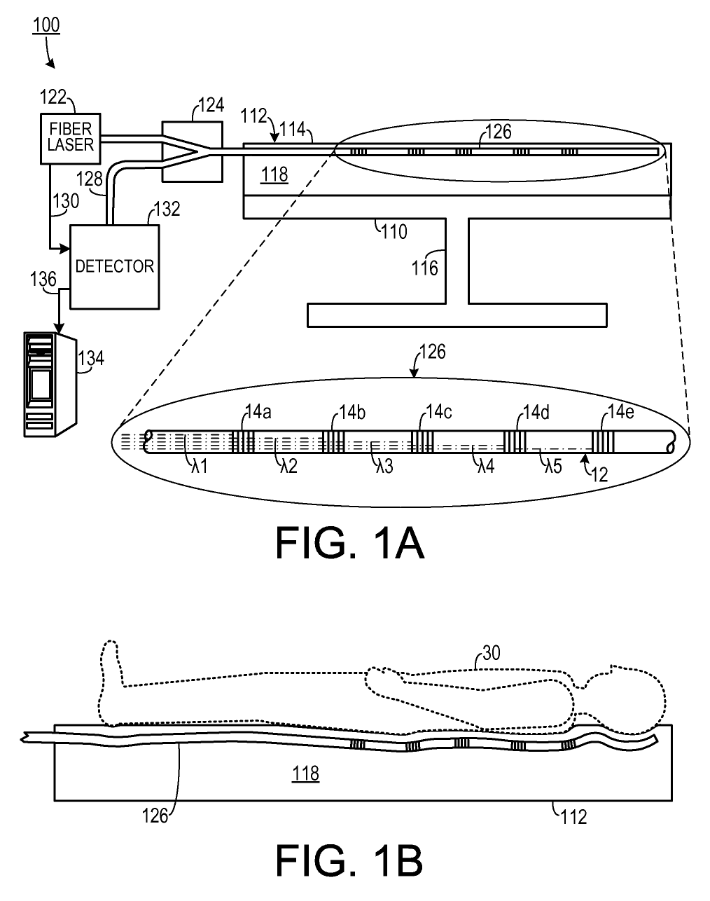

As shown in FIGS. 1A and 1B, one illustrative embodiment of the invention includes an optical patient parameter sensor system 100 for mapping an anatomical characteristic of a patient. The mechanism includes a treatment bed 112 having a top surface 114. The treatment bed 112 can include a mattress portion 118 that rests on a platform 110 and that may be spaced apart from the floor by a pedestal 116, or other support mechanism.

A fiber Bragg grating channel 126 is disposed along at least a portion of the treatment bed 112 near the top surface 114. As seen in the detail, the fiber Bragg grating channel 126 includes a fiber optic waveguide 12 that defines a plurality of spaced-apart Bragg-type gratings 14a-e. (While only five Bragg-type gratings are shown for the sake of clarity, it should be understood that many embodiments would employ more Bragg-type gratings—possibly substantially more—or even fewer Bragg-type gratings.) Each Bragg-type grating is configured so as to be able to reflect a different wavelength of light. In the example shown, Bragg-type grating 14a is configured to reflect wavelength λ1, Bragg-type grating 14b is configured to reflect wavelength λ2, Bragg-type grating 14c is configured to reflect wavelength λ3, Bragg-type grating 14d is configured to reflect wavelength λ4, and Bragg-type grating 14e is configured to reflect wavelength λ5.

A multi-wavelength broadband light source 122, or a swept fiber laser, generates a plurality of beams of different wavelengths that are injected into the fiber Bragg grating channel 126 through an optical coupler 124. An optical detector 132 is also in optical communication with the fiber Bragg grating channel 126 through the optical coupler 124. The detector receives a portion of the reflected optical beams 128 and a signal 130 regarding the sent optical beams from the light source 122. The detector 132 detects reflections of light from at least one of the Bragg-type gratings 14a-e and generates a signal 136 indicative of that amount of time that each beam spends traveling from the light source 122 to a selected Bragg-type grating 14 and back to the detector 132. A computer 134, which is in communication with the detector 132, is programmed to calculate at least one anatomical characteristic based on a characteristic of at least one of the reflection of light beams.

When the fiber Bragg grating channel 126 is manipulated, the optical path of a light beam passing therethrough changes. For example, if a portion of the fiber Bragg grating channel 126 is bent, the optical path of a light beam passing therethrough is longer than if the fiber Bragg grating channel 126 were in an unbent state. Similarly, if a portion of the fiber Bragg grating channel 126 changes temperature, then the index of refraction of the portion may also be changed, thereby changing the amount of time that a light beam would take to pass through the portion. By measuring the amount of time that a beam of light of a given wavelength takes to travel from the light source to a predetermined fiber Bragg-type grating 14 to the optical detector 132, one can determine the length of the optical path that the beam of light travels. By comparing the optical paths of different portions of the fiber Bragg grating channel 126, corresponding to the portions between different pairs of fiber Bragg-type gratings 14, information about the optical path between any two Bragg-type gratings can be derived from a plurality of reflected signals. By combining the information about different portions, one can derive an understanding of such parameters regarding the patient as topographic characteristics (e.g., the shape of the contours of the patient's back) and metabolic characteristics (e.g., localized temperature differences) of the patient 30.

In one experimental embodiment, the optical detector 132 employed was a model S1425 Optical Sensing Interrogator, available from Micron Optics Inc., 1852 Century Place NE, Atlanta, Ga. 30345. Also, custom fiber Bragg gratings can be obtained from O/E Land, Inc., 4321 Garand, Saint-Laurent, Quebec, Canada H4R 2B4.

A patient 30 is shown lying on a treatment bed 112 in FIG. 1B. It can be seen that the fiber Bragg grating channel 126 is deformed as a result of patient's 30 pressure points deforming the mattress 118.

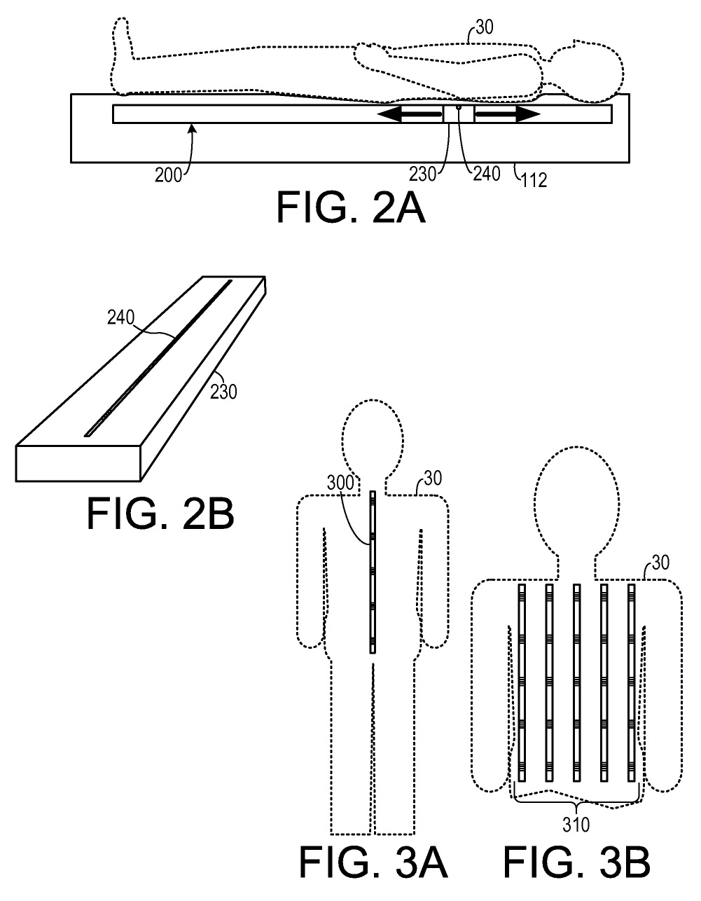

As shown in FIG. 2A, in one embodiment, the invention could include a track 200 upon which is mounted a moveable scanning mechanism 230 disposed adjacent to the top surface of the treatment bed 112. The scanning mechanism 230 includes a fiber Bragg grating channel 240 that is moveable along the track 200 so as to be moveable relative to a plurality of positions relative to the patient 30. The track may include a computer-controlled device (not shown) that moves the scanning mechanism 230 according to preprogrammed commands from the computer 134. The scanning mechanism 230 is shown in greater detail in FIG. 2B.

As shown in FIG. 3A, a single fiber Bragg grating channel 300 may be applied directly to a portion of the patient's 30 anatomy through the use of tape, etc. This embodiment allows for direct measurement of various points of the patient's 30 anatomy. Similarly, as shown in FIG. 3B, one embodiment could include an array of spaced-apart fiber Bragg grating channels 310 so as to facilitate generation of a multi-dimensional map of the anatomical characteristic. Such an embodiment could be embedded in the mattress 118 or applied directly to a selected portion of the patient's 30 anatomy.

The embodiments shown in FIG. 3 and FIG. 4B may be used to generate a multi-dimensional map of an anatomical characteristic. For example a two- or three-dimensional temperature profile of the patient's back may be generated. Similarly, a two- or three-dimensional contour map of the patient's back could be generated. The information of the contour map could be combined graphically with a temperature profile, correlating local temperature characteristics with pressure points. With this invention, such maps could be generated substantially in real time, providing clinicians with valuable information that may be incorporated into a treatment regimen.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A mechanism for mapping an anatomical characteristic of a patient, comprising:
a. a treatment bed having a top surface;
b. a fiber Bragg grating channel disposed along at least a portion of the treatment bed near the top surface, the fiber Bragg grating channel including a fiber optic waveguide defining a plurality of spaced-apart Bragg-type gratings;
c. a multi-wavelength light source that generates a beam that is in optical communication with the fiber Bragg grating channel;
d. a detector, in optical communication with the fiber Bragg grating channel, that detects reflections of light from at least one of the Bragg-type gratings; and
e. a computer, in communication with the detector, that is programmed to calculate at least one anatomical characteristic based on a characteristic of at least one of the reflection of light.

2. The mechanism of claim 1, wherein the anatomical characteristic comprises a topographic characteristic.

3. The mechanism of claim 1, wherein the anatomical characteristic comprises a metabolic characteristic.

4. The mechanism of claim 3, wherein the metabolic characteristic comprises a temperature.

5. The mechanism of claim 1, wherein each of the plurality of Bragg-type gratings is tuned so as to reflect a different wavelength of light.

6. The mechanism of claim 1, wherein the multi-wavelength light source comprises a broadband wave source.

7. The mechanism of claim 1, wherein the multi-wavelength light source comprises a multi-wavelength light source comprises a swept laser.

8. The mechanism of claim 1, further comprising a plurality of spaced-apart fiber Bragg grating channels, each fiber Bragg grating channel in optical communication with the multi-wavelength light source and the detector, the plurality of spaced-apart fiber Bragg grating channels facilitating generation of a multi-dimensional map of the anatomical characteristic.

9. The mechanism of claim 1, further comprising a moveable scanning mechanism disposed adjacent to the top surface of the treatment bed, wherein the fiber Bragg grating channel is moveable along a track so as to be moveable relative to a plurality of positions relative to the patient.

10. A treatment bed for a patient, comprising:
a. a platform capable of supporting the patient;
b. a mattress, having a top surface, disposed on the platform; and
c. a fiber Bragg grating channel disposed along at least a portion of the mattress near the top surface, the fiber Bragg grating channel including a fiber optic waveguide defining a plurality of spaced-apart Bragg-type gratings.

11. The treatment bed of claims 10, wherein the fiber Bragg grating channel is embedded in at least a portion of the mattress.

12. The treatment bed of claim 10, further comprising a moveable scanning mechanism disposed adjacent to the top surface of the mattress, wherein the fiber Bragg grating channel is moveable within the scanning mechanism to as to be moveable relative to a plurality of positions relative to the patient.

13. A method of measuring an anatomical characteristic of a patient, comprising the steps of:
a. placing a fiber Bragg grating channel, including a fiber optic waveguide defining a plurality of spaced-apart Bragg-type gratings, in a position so as to have at least one optical characteristic of the fiber Bragg grating channel changed in correspondence with the anatomical characteristic;
b. injecting a light beam from a multi-wavelength light source into the fiber Bragg grating channel;
c. measuring, with a detector, a value of at least one parameter of a beam reflected out of the fiber Bragg grating channel;
d. calculating the anatomical characteristic based on the value.

14. The method of claim 13, wherein the parameter comprises a reflection time of a predetermined wavelength of light.

15. The method of claim 13, wherein the anatomical characteristic comprises a topographic characteristic.

16. The mechanism of claim 13, wherein the anatomical characteristic comprises a metabolic characteristic.

17. The mechanism of claim 16, wherein the metabolic characteristic comprises a temperature.

18. The method of claim 13, wherein the measuring step comprises measuring a time for a portion of the beam having a predetermined wavelength to transit from the multi-wavelength light source to a selected one of the Bragg-type gratings corresponding to the predetermined wavelength and to the detector.

19. The method of claim 13, further comprising the steps of:
a. injecting a light beam from a multi-wavelength light source into a plurality of fiber Bragg grating channels;
b. measuring a plurality of values of at least one parameter of a beam reflected out of each of the fiber Bragg grating channels; and
c. generating a multi-dimensional map of the anatomical characteristic based on each of the values, thereby generating a multi-dimensional map of the anatomical characteristic.

20. The method of claim 13, further comprising the step of moving the fiber Bragg grating channel along a predetermined path relative to the patient so as to facilitate the generation of a multi-dimensional map of the anatomical characteristic.
